(19) United States
(12) Patent Application Publication
(10) Pub. No.: US 2016/0264348 A1
(43) Pub. Date: Sep. 15, 2016

(54) BEVERAGE CARTRIDGES AND METHODS

(71) Applicant: Starbucks Corporation d/b/a Starbucks Coffee Company, Seattle, WA (US)

(72) Inventors: Paul N. Camera, Sammamish, WA (US); John Brockman, Edmonds, WA (US)

(21) Appl. No.: 15/065,643

(22) Filed: Mar. 9, 2016

Related U.S. Application Data
(60) Provisional application No. 62/131,732, filed on Mar. 11, 2015.

(51) Int. Cl. B65D 85/804; B65B 31/00; B65B 29/02; A23F 5/00; B65B 7/16

(52) U.S. Cl. CPC B65D 85/8043; A23F 5/00; B65B 7/16; B65B 29/02; B65B 31/00

(57) ABSTRACT

Present embodiments generally related to a single-serve beverage cartridge for use with a beverage machine. In some embodiments, the cartridge includes a cup, a lid, and a beverage component disposed in the cup. The beverage component can include a soluble beverage component and a non-soluble beverage component. In certain instances, the beverage component in the beverage cartridge can include a first layer of non-soluble beverage component and a second layer of soluble beverage component. In other instances, the beverage component can include a first layer of soluble beverage component and a second layer of non-soluble beverage component. In other instances, the beverage component can include a first layer of non-soluble beverage component, a second layer of soluble beverage component, and a third layer of non-soluble beverage component. In other instances, the beverage component can include a mixture of soluble beverage component and non-soluble beverage component. The soluble and non-soluble beverage components can be the soluble and non-soluble components of a same or similar type of beverage.

This application claims a priority benefit under 35 U.S.C. §119 of U.S. patent application Ser. No. 62/131,732, filed Mar. 11, 2015, the entirety of which is hereby incorporated by reference herein.

### FIELD

The present disclosure relates to a sealed cartridge with a soluble beverage component and an insoluble beverage component for producing a beverage when fluid is introduced into the cartridge. The cartridge can be configured for use with single-serve beverage machines.

### DESCRIPTION OF CERTAIN RELATED ART

Single-serve beverage machines are devices that are designed to produce a single serving, or sometimes a single cup, of a desired beverage. In comparison to other types of beverage machines (such as drip coffee makers having a multi-cup carafe), single-serve beverage machines can enhance convenience by reducing the time to prepare the beverage. Furthermore, single-serve beverage machines can reduce waste by decreasing the likelihood of producing excess amounts of the beverage, which may go unused and be subsequently discarded.

Some single-serve beverage machines use a cartridge (also called a pod or capsule) containing substantially non-soluble coffee grounds to produce the beverage. Generally, such cartridges are received in the single-serve beverage machine, are used to produce the single serving of the beverage, and are subsequently manually removed from the machine and discarded.

### SUMMARY OF THE DISCLOSURE

In certain applications, the size and/or volume of a cartridge for a single-serve beverage machine may be limited. As a result, the cartridge may not provide enough room to accommodate the recommended quantity of non-soluble beverage component to dispense a beverage of a certain volume from a beverage machine. Accordingly, in some embodiments, a cartridge is provided with a soluble beverage component in conjunction with a non-soluble beverage component. The soluble beverage component can provide additional flavor per unit volume within the cartridge than a cartridge with only a non-soluble component. In this manner, the intended flavor profile can be achieved for a greater range of beverage volumes formed from a fixed cartridge volume while still providing the flavor advantages and benefits of the non-soluble component. In certain embodiments, the soluble beverage component and the non-soluble beverage component are soluble and non-soluble components of the same or similar type of beverage, such as coffee. Thus, in an embodiment where the beverage is coffee, the soluble beverage component can comprise instant coffee and the non-soluble component can comprise roasted ground coffee. In an embodiment where the beverage is tea, the soluble beverage component can comprise instant tea and the non-soluble component can comprise tea leaves. A combination of a soluble beverage component and a non-soluble beverage component can enhance the desired body and flavor profile for a cartridge over a wider range of beverage volumes provided by a beverage machine.

In certain configurations, the cartridge can include a beverage component composed of a predetermined ratio of soluble beverage component and non-soluble beverage component. Similarly, the soluble beverage component and non-soluble beverage component can be provided in one or more layers within the cartridge or thoroughly mixed prior to placement within the cartridge. In some configurations, the soluble beverage component comprises dry coffee extract and the non-soluble beverage component comprises roasted ground coffee. In certain configurations, the soluble beverage component can include microground coffee and dry coffee extract. In certain embodiments, the cartridge can include a lid and a bottom wall that can be configured to be pierced to allow the flow of liquid therethrough. In certain embodiments, the cartridge can include a filter element to retain the non-soluble beverage component within the cartridge.

In some embodiments, a method of assembling a cartridge for producing a beverage is described. In some arrangements, a method for filling a cartridge with a predetermined ratio of soluble beverage component and non-soluble beverage component is provided. In some arrangements, the soluble beverage component and the non-soluble beverage component are introduced into the cartridge via separate feed mechanisms and/or discrete steps. In some arrangements, the soluble beverage component and the non-soluble beverage component are fed into the cartridge such that the cartridge has a first layer of soluble beverage component and a second layer of non-soluble beverage component. In some arrangements, the cartridge has a first layer of non-soluble beverage component and a second layer of soluble beverage component. In some arrangements, the cartridge has a first layer of soluble beverage component, a second layer of non-soluble beverage component, and a third layer of soluble beverage component. In some arrangements, a predetermined ratio of the soluble beverage component and non-soluble beverage component is first mixed before filling the cartridge.

### BRIEF DESCRIPTION OF THE FIGURES

Various embodiments are depicted in the accompanying drawings for illustrative purposes, and should in no way be interpreted as limiting the scope of the embodiments. Furthermore, various features of different disclosed embodiments can be combined to form additional embodiments, which are part of this disclosure.

FIG. 1A illustrates a cross-sectional view of an embodiment of a cartridge with a beverage component including a first layer of non-soluble beverage component and a second layer of soluble beverage component.

FIG. 1B illustrates a cross-sectional view of an embodiment of a cartridge of FIG. 1A with a beverage component including a first layer of soluble beverage component and a second layer of non-soluble beverage component.

FIG. 1C illustrates a cross-sectional view of an embodiment of a cartridge of FIG. 1A with a beverage component including a first layer of non-soluble beverage component, a second layer of soluble beverage component, and a third layer of non-soluble beverage component.

FIG. 1D illustrates a cross-sectional view of an embodiment of a cartridge of FIG. 1A with a beverage component including a combination of soluble beverage component and non-soluble beverage component.

FIG. 1E illustrates a cross-sectional view of an alternative embodiment of a cartridge with the beverage component illustrated in FIG. 1A including a combination of non-soluble beverage component and soluble beverage component.

FIG. 2A illustrates a schematic representation of an embodiment of a method for assembling the beverage cartridge illustrated in FIG. 1A.

FIG. 2B illustrates a schematic representation of an embodiment of a method for assembling the beverage cartridge illustrated in FIG. 1B.

FIG. 2C illustrates a schematic representation of an embodiment of a method for assembling the beverage cartridge illustrated in FIG. 1C.

FIG. 2D illustrates a schematic representation of an embodiment of a method for assembling the beverage cartridge illustrated in FIG. 1D.

FIG. 3A illustrates a flow chart of a method for assembling a beverage cartridge as illustrated in FIG. 2A.

FIG. 3B illustrates a flow chart of a method for assembling a beverage cartridge as illustrated in FIG. 2B.

### DETAILED DESCRIPTION

The following discussion is presented to enable a person skilled in the art to make and use one or more of the described embodiments. The general principles described herein may be applied to embodiments and applications other than those detailed below without departing from the spirit and scope of the disclosure. Indeed, the described embodiments are not intended to be limited to the particular embodiments shown, but are to be accorded the widest scope consistent with the principles and features disclosed or suggested herein.

### Certain Cartridge Structures

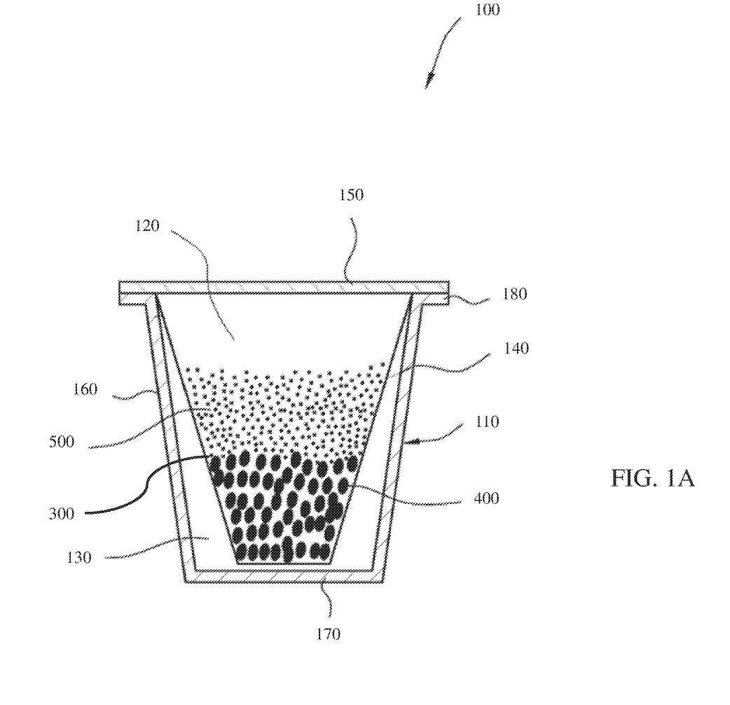

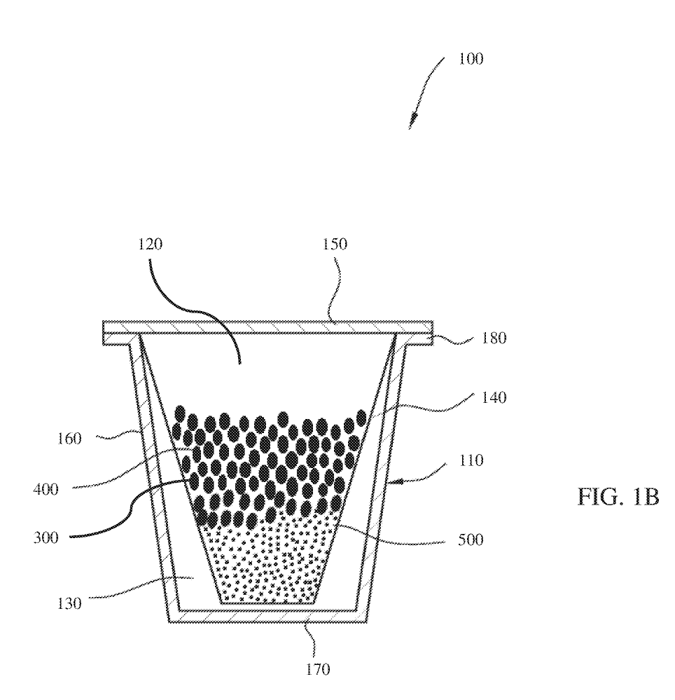

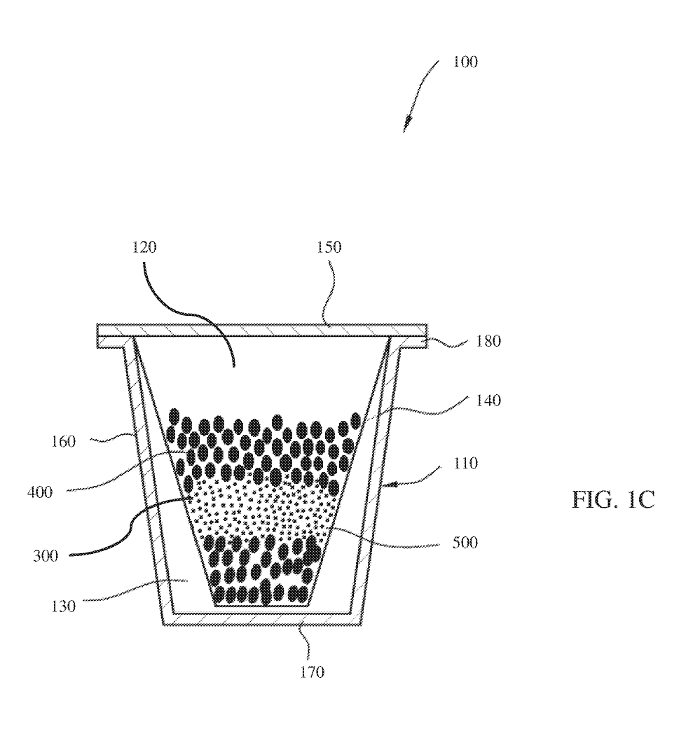

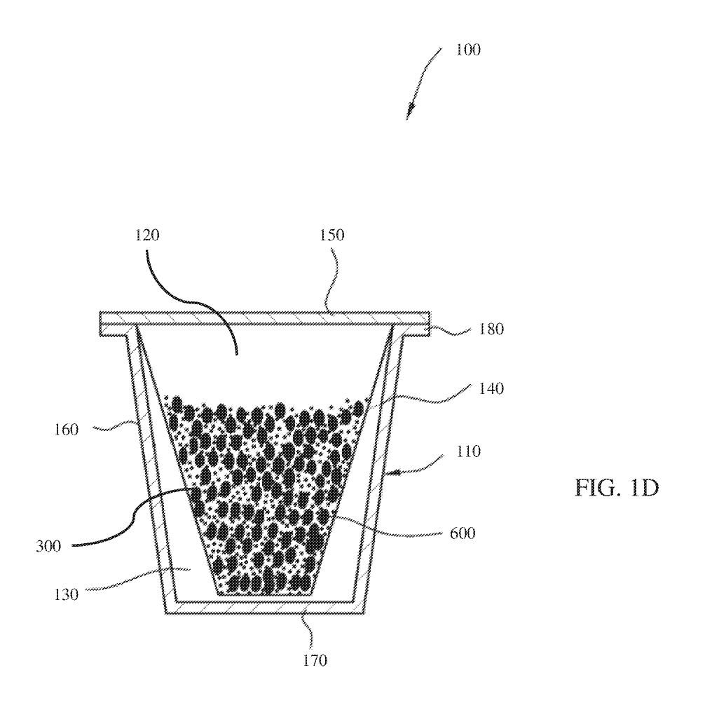

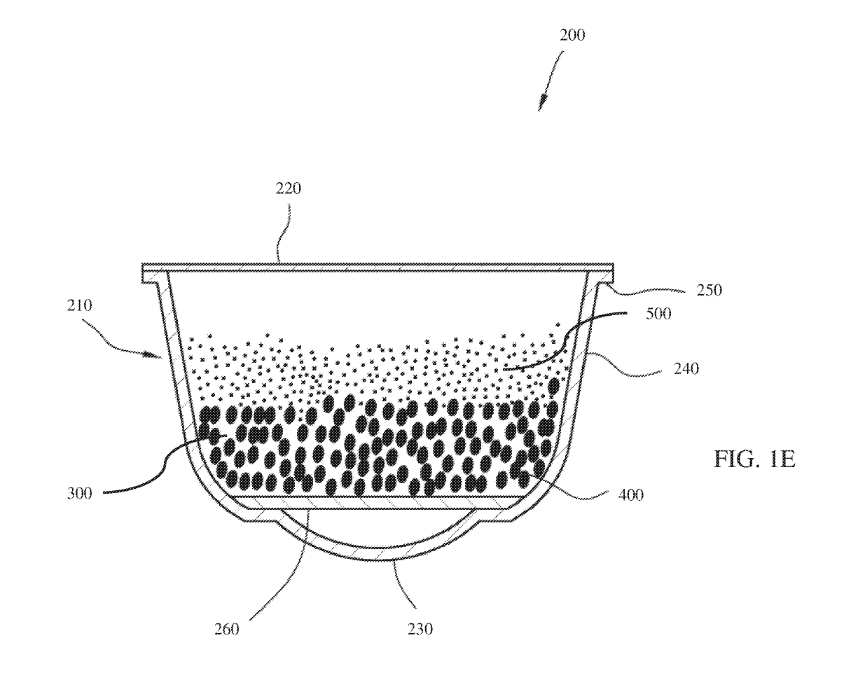

FIGS. 1A-D illustrate cross-sectional views of some embodiments of a cartridge 100. The specific structure of the cartridge 100 described below is not intended to be limiting but provides one example carrier for the beverage component 300 described below.

As described herein, the size and/or volume of a cartridge for a beverage machine may be limited. As a result, the cartridge may not provide enough room to accommodate the recommended quantity of non-soluble beverage component to dispense a beverage of a certain volume from a beverage machine. Accordingly, in certain embodiments describe below, the cartridge 100 can be provided with a soluble beverage component in combination with a non-soluble beverage component. As described herein, the soluble beverage component and the non-soluble beverage component can be soluble and non-soluble components of the same type of beverage, such as coffee. Thus, in an embodiment where the beverage is coffee, the soluble beverage component can comprise instant coffee and the non-soluble component can comprise roasted ground coffee. A combination of a soluble beverage component and a non-soluble beverage component can enhance the desired body and flavor profile for a cartridge over a wider range of beverage volumes provided by a beverage machine

Referring to FIGS. 1A-D, a cartridge 100 can include a cup 110, a lid 150 and a filter element 140. In some embodiments, the cartridge has no filter. In some embodiments, the cup 110 can have a generally hollow structure having a bottom wall 170, a protruding lip 180 and a sidewall 160. In other embodiments, the cartridge 100 can have a gradually tapered, generally cylindrical shape; however, other shapes can be used without departing from the spirit and/or scope of the disclosure.

The cup can include an outwardly protruding lip 180. In some embodiments, the lid 150 is secured to the radially outwardly protruding lip 180 surrounding an access opening. The lid 150 can be secured, adhered, or otherwise connected with the outwardly protruding lip 180 or adjacent thereto, thereby forming a sealed cartridge 100. The seal can be an airtight seal to reduce entry of ambient air into the cartridge 100 and thus promote freshness of the beverage component 300. The lid 150 can be secured or adhered to the cartridge 100 using any suitable adhesive or sealing techniques and materials, such as heat-sealing, crimping, gluing, UV-curing, applying ultrasonic or microwave energy (e.g., sonic welding), and otherwise.

In additional variants, the filter element 140 can be disposed within the cup 110 and attached to the cup 110 adjacent the lid 150. The filter element 140 can define a first chamber 120 and a second chamber 130. In some examples, the first chamber 120 can contain a beverage component 300 for producing a brewed beverage when water is introduced into the cartridge 100. In some embodiments, during the brewing process, the lid 150 is pierced so that liquid is introduced into the first chamber 120 and mixes with the beverage component 300. In some examples, the brewed beverage can then pass through the filter element 140 (which removes non-soluble components of the used beverage component 300 from the brewed beverage) and into the second chamber 130. In some examples, the brewed beverage then exits the cartridge 100 through the bottom wall 170 of the cartridge 100, which has also been pierced to produce an opening.

The cup 110 and the lid 150 can be constructed of a liquid-impermeable material that is capable of being pierced or perforated by a piercing member of a single-serve beverage machine to allow the introduction of liquid (e.g., hot water or cold water) into the cartridge 100. For example, the cup 110 and the lid 150 can be made of one or more metallic (e.g., aluminum), paper-based, polymeric (e.g., plastic, polyethylene, polyurethane, nylon), and/or biodegradable materials. In some embodiments, the cup 110 and/or the lid 150 is constructed of a flexible material. In certain instances, the lid 150 of the cartridge 100 can be pierced or perforated by a piercing member. In such cases, liquid can be injected or otherwise delivered through a piercing member and/or the opening created therefrom into the cup 110, thereby forming a beverage within the cup 110. In other instances, the lid 150 may be constructed of a gas and/or water permeable material that allows a liquid, such as water, to pass through without requirement piercing of the lid.

In some embodiments, the introduction of liquid into the cartridge 100 encourages mixing of the liquid and the beverage component 300. For example, the liquid can be introduced as a pressurized (e.g., between about 0.5 bars and about 20 bars) stream, which can impinge the beverage component 300 and/or the cup 110 (e.g., the bottom wall 170) and facilitate mixing. In some embodiments, the liquid is injected in a manner such that liquid and instant beverage component are effectively churned or swirled within the cup 110, thereby allowing the beverage particles to be dispersed and/or dissolved more readily. For example, in some such cases the liquid is injected in a cyclonic fashion.

In some embodiments, the liquid introduced into the cartridge is water. For example, in some embodiments, use other types of liquid. For example, in certain embodiments, the liquid is milk, such as for the preparation of hot cocoa. In other embodiments, the liquid is a juice. In some embodiments, the liquid is carbonated, such as for the preparation of a soft drink. In certain embodiments, the liquid is alcoholic, such as for the preparation of a shot or a cocktail. In some instances, a hot liquid is introduced, e.g., for hot beverages. In other instances, a cold liquid is introduced, e.g., for iced beverages. The amount of liquid introduced can be predetermined or adjusted based on a desired strength of the beverage.

In some embodiments, after the cartridge has been pierced by a first piercing member, the liquid has been introduced into the cartridge, and the beverage components have been at least partly mixed with and/or dissolved into the liquid, the beverage is ready to exit the cartridge. Accordingly, in some instances, the cup 110 can be configured to provide a location for the liquid to exit the cartridge 100. For example, the bottom wall 170 can be configured to be pierced or perforated by a piercing member to allow the prepared beverage to exit the cartridge 100. The piercing member can be a hollow needle or cannula-like element, such that the prepared beverage can flow through the second piercing member for delivery to a cup or other beverage receptacle for consumption (e.g., via a discharge spout). In some embodiments, the prepared beverage does not flow through a piercing member, rather the prepared beverage exits via a hole or opening formed by a piercing member. In certain embodiments, a piercing member pierces approximately the center (e.g., radial center) of the bottom wall 170. In yet other embodiments the cartridge may be fabricated with one or more holes or openings in the bottom wall 170. In such embodiments, the hole(s) may be sealed by a removable tab or other covering that may be stripped from the bottom wall 170 prior to use. In yet other embodiments, the bottom wall 170 is constructed of a gas and/or impermeable material that can allow the formed beverage to pass through without requiring piercing or removal of any tab or covering.

In certain arrangements, components of the cartridge 100 are constructed of a flexible material. For example, in some embodiments, the cup 110 is sufficiently flexible to be able to collapse and expand. Such a configuration can, for example, reduce the storage space occupied by the cartridge 100 and reduce the likelihood of air or other gasses spoiling or otherwise degrading the beverage component 300. In some cases, the cup 110 is collapsed around the beverage component 300. In some cases, air or other gases are substantially evacuated from the cartridge 100. In some embodiments, the cup 110 is configured to expand when the liquid is introduced into the cartridge 100. In certain such cases, the cup 110 expands to about its size and shape prior to collapse.

FIG. 1E illustrates another example of a cartridge 200. In some embodiments, the cartridge 200 includes a cup 210 with a bottom wall 230, a sidewall 240, and a lid 220. The lid 220 can be sealed with a lip 250 of the cartridge 200. The cartridge 200 can include a barrier 260 to prevent leakage of the coffee grounds from the cartridge 200 when the capsule is pierced during the coffee brewing process. During the brewing process, the bottom wall 230 of the capsule is pierced so that water is introduced into the cartridge 200 and mixes with the beverage component 300. The brewed espresso beverage then exits through the lid 220 of the cartridge 200, which lid 220 has been ruptured to produce a number of openings or perforations. As illustrated, the beverage cartridge 200 can include a first layer of non-soluble beverage component 400 and a second layer of soluble beverage component 500.

In various embodiments, the cartridges described herein can be made of biodegradable or otherwise “environmental friendly” materials. The cartridges described herein can be configured for single use. The cartridges described herein can be compatible with one or more existing single-serve beverage machines or technologies. The cartridge described herein can be configured to deliver a “single-serving” of beverage. The term “single serving” has its ordinary and customary meaning, and includes, among other things, a portion of beverage that is customarily consumed by one person. For example, some single-serving beverage pods are configured to produce less than or equal to about 20 fluid ounces (about 600 milliliters) of beverage. While several embodiments described herein are described with respect to single serving applications, this disclosure is not limited to such applications and certain embodiments can also be applied to cartridges configured for larger than a single serving.

In some embodiments, the cartridge can be vacuum sealed or pressurized. In some embodiments, the oxygen or ambient air in the cartridge is replaced with nitrogen (or another generally non-reactive gas). In certain other embodiments, the oxygen or ambient air in the cartridge is replaced with a combination of nitrogen and carbon-dioxide. Replacement of the oxygen or ambient air in the cartridge can, for example, enhance the shelf-life of the cartridge and reduce the chance of spoliation or degradation of the contents of the cartridge. In some embodiments, one or more portions of the cartridge (e.g., the cup and/or the lid) are configured to limit or otherwise control the transmission of water vapor and/or oxygen between the beverage component and an external environment (e.g., ambient air) in order to provide an acceptable shelf life. For example, in some cases, the lid has a water vapor transmission rate of less than or equal to about 0.050 g/m²/day (measured as per ASTM F-1249). In certain embodiments, the lid has an oxygen transmission rate of less than or equal to about 0.500 cc/m²/day (measured as per ASTM D3985). Those skilled in the art will recognize that such transmission rates are illustrative and thus, should not be construed as limiting. In some instances, an acceptable shelf life is between about 6 months and about 12 months after assembly of the cartridge. However, depending on the contents of the cartridge, a shelf life that is shorter (e.g., about 3 months) or longer (e.g., about 18 months) may be applicable and is contemplated by this disclosure.

The cartridge can include a single serving, or single-serve portion, of the beverage component, such as instant coffee, tea, fruit juice, soft drink, or any other beverage that can be produce by mixing one or more substantially soluble beverage components with a fluid. The term soluble as used herein shall be given its ordinary and customary meaning, and shall include, without limitation, products that readily dissolve or disperse in a liquid, such as water or milk. Similarly, the term non-soluble as used herein shall be given its ordinary and customary meaning, and shall include, without limitation, products that do not readily dissolve in a liquid, such as water or milk. As will be described below, the cartridge can include a combination of soluble beverage component and a non-soluble beverage component. The soluble beverage component and a non-soluble beverage component can be components of the same type of beverage, such as coffee.

In some embodiments the soluble beverage component can be composed of dissolvable beverage components such as a dried (e.g. freeze-dried, hot air dried, or any other drying process) coffee, tea, fruit juice, dairy or cocoa-based beverage. In other embodiments, the soluble beverage component can be composed of other dissolvable beverage components that can include, but is not limited to, dairy, soy, sugar, artificial sweeteners, nutrients, flavorings, or other soluble components, in addition to, for example, coffee, tea, fruit juice, dairy or cocoa-based beverage.

In some embodiments, the soluble beverage component can include a portion of microground or pulverized coffee, such as that described in U.S. Patent Application Publication No. 2010/0009039, filed Jul. 9, 2008, and titled “METHOD OF MAKING BEVERAGES WITH ENHANCED FLAVORS AND AROMAS,” the entirety of which is incorporated herein by reference. For example, in some cases, the soluble beverage component can include coffee having a median or mean particle size of about 350 microns or less. In some embodiments, the soluble beverage component includes a combination of freeze-dried coffee and microground coffee.

In some embodiments, the non-soluble beverage component can be composed of a beverage component that is not readily dissolvable such as coffee grounds, tea leaves, fruits, and any other particles that can be used to impart flavor into the beverage without being readily dissolvable. In some embodiments, the non-soluble beverage component is retained within the cartridge 100 by a filter element (e.g., such as the filter element 140 described above) such that the prepared beverage does not contain undesirable textures associate with components that are not readily dissolvable.

### Certain Cartridge Components

As described above, the cartridge can include soluble and non-soluble beverage components. In certain embodiments, the soluble beverage component and the non-soluble beverage component can be combined within the cartridge to form a mixed beverage component. As discussed, in some examples, the soluble beverage component and the non-soluble beverage component can be at a predetermine ratio. In some embodiments, additional beverage components can be combined within the cartridge, including but not limited to dairy, soy, sugar, artificial sweeteners, nutrients, flavorings, or other soluble components, in addition to, for example, coffee, tea, fruit juice, dairy or cocoa-based beverage. As mentioned above, the non-soluble beverage component and the soluble beverage can be soluble and non-soluble components of the same beverage, such as coffee.

The type and amount of beverage component and/or the ratio of soluble to non-soluble components can be selected to provide a beverage having certain desired characteristics. For example, the amount of soluble beverage component 500 can be selected to deliver a predetermined strength of beverage given a fixed cartridge size and/or volume. The type and amount soluble and non-soluble beverage components within the cartridge can also depend upon the size and/or type of cartridge and the beverage sized delivered by the cartridge. Accordingly, the ratio of soluble beverage component to non-soluble beverage component can vary in light of the disclosure herein to provide a beverage having certain desired characteristics and are not limited to the following non-limiting example arrangements and embodiments.

In certain arrangements, the ratio of soluble beverage component to non-soluble beverage component can include ratios of, for example, 1:22, 1:23, 1:24, 1:25, 1:26, 2:22, 2:23, 2:24, 2:25, 2:26, 3:22, 3:23, 3:24, 3:25, 3:26, 4:22, 4:23, 4:24, 4:25, 4:26, values between the aforementioned values, or other values. In certain arrangements, the soluble beverage component can comprise 3% to 16% of the total weight of the soluble and non-soluble beverage components 500, 400 within the cartridge and in certain arrangements 2% to 18% of the total weight of the soluble and non-soluble beverage components 500, 400 within the cartridge, and in certain embodiments 1% to 22% of the total weight of the soluble and non-soluble beverage components 500, 400 within the cartridge. In certain arrangements, the soluble beverage component 500 can comprise about 3% to about 16% of the total weight of the soluble and non-soluble beverage components 500, 400 within the cartridge and in certain arrangements about 2% to about 18% of the total weight of the soluble and non-soluble beverage components 500, 400 within the cartridge, and in certain embodiments about 1% to about 22% of the total weight of the soluble and non-soluble beverage components 500, 400 within the cartridge. In certain embodiments, the ratio of non-soluble beverage component 400 to soluble beverage component 500 can include ratios of 26:1, 26:2, 26:3 and in certain arrangements 14:1, 14:2, and 14:3 and in certain arrangements 7:1 7:2 and these arrangements can also include values between the aforementioned values, or other values In certain arrangements, the above ratios and/or weight percentages can apply to arrangements where the non-soluble beverage component 400 and the soluble beverage 500 can be soluble and non-soluble components of the same beverage, such as coffee, tea or any of the beverages described herein. In certain arrangements, the above ratios and/or weight percentages can apply to arrangements where the non-soluble beverage component is roasted ground coffee and the soluble beverage can be soluble coffee such as coffee extract, freeze-dried and/or instant coffee.

In some arrangements configured for single servings, the cartridge comprises 22 to 26 grams of non-soluble beverage component and 1 to 4 grams of soluble beverage component. In some arrangements configured for single servings, the cartridge comprises about 22 to about 26 grams of non-soluble beverage component and about 1 to about 4 grams of soluble beverage component. In some arrangements, the cartridge comprises 22 to 26 grams of non-soluble coffee component such as roasted ground coffee and 1 to 4 grams of soluble coffee component such as coffee extract, freeze-dried and/or instant coffee. In some arrangements, the cartridge comprises about 22 to about 26 grams of non-soluble coffee component such as roasted ground coffee and about 1 to about 4 grams of soluble coffee component such as coffee extract, freeze-dried and/or instant coffee.

FIG. 1A illustrates a cartridge 100 with a first layer of non-soluble beverage component 400 and a second layer of soluble beverage component 500. In this arrangement, the layer of soluble beverage component 500 can be positioned on top of the layer of non-soluble beverage component 400. In the illustrated arrangement, the second layer of soluble beverage component 500 can form the upper most or top layer of the beverage components positioned within the cartridge 100. In one embodiment, the layer of soluble beverage component 500 is positioned within the top half of the depth of components within the cartridge, in another embodiment, within the top third, and in another embodiment, within the top quarter of the depth of the components within the cartridge.

FIG. 1B illustrates a cartridge with a first layer of soluble beverage component 500 and a second layer with a non-soluble beverage component 400. In this arrangement, the layer of soluble beverage component 500 can be positioned below the layer of non-soluble beverage component. In this arrangement, the soluble beverage component 500 can form the lower-most or bottom layer of the beverage components within the cartridge 100. In one embodiment, the layer of soluble beverage component 500 is positioned within the bottom half of the depth of components within the cartridge, in another embodiment, within the bottom third, and in another embodiment, within the bottom quarter of the depth of the components within the cartridge.

Layering of the soluble 500 and non-soluble beverage components 400 of the beverage component 300 (such as is illustrated in FIGS. 1A-B) can aid in providing the cartridge with a prescribed amount and/or proportion of soluble beverage component 500 to non-soluble beverage component 400. For example, as will be discussed in more detail below, layering can reduce or avoid problems associated with the fine granular size of the soluble beverage component 500. In some embodiments, layering can avoid or reduce problems associated with mixing the non-soluble and soluble components together before insertion into the cartridge. For example, layering can reduce or avoid issues associated with mixing components of different densities

In some instances, layering can facilitate transport and/or manufacturability of the cartridge. For example, in the layered approach, the soluble and non-soluble components can be maintained, transported, and/or inserted into the cartridge as separate components. In contrast, in a mixed approach, the soluble and non-soluble components are mixed, transported, and inserted into the cartridge as combined components. In certain instances, the mixed components can stratify during mechanical transport (e.g., before insertion into a pod), which can lead to and inconsistent proportions of the soluble and non-soluble components being inserted into the cartridge during manufacturing.

FIG. 1C-D illustrates certain additional configurations of the beverage component 300. FIG. 1C illustrates a cartridge with a first layer of non-soluble beverage component 400, a second layer of soluble beverage component 500, and non-soluble beverage component 400. Thus, in the illustrated arrangement, the soluble beverage component 500 can comprise one or more layers between layers of the non-soluble beverage component 400 or the non-soluble beverage component 400 can comprise one or more layers between layers of soluble beverage component 500.

FIG. 1D illustrates a cartridge with a beverage component 300 composed of a mixed beverage component 600. In some embodiments, the mixed beverage component 600 is mixed in the desired ratio of soluble beverage component 500 to non-soluble beverage component 400 described above. The combination of the soluble beverage component and non-soluble beverage component can be combined by one or more of many different methods, e.g., centrifugal equipment, lightning mixer, ribbon blender, PK blender, sonic methods, etc. In some embodiments, other compounds may be added during the mixing process, including beverage component oils, beverage component aromas, etc. The soluble beverage component 500 and the non-soluble beverage component 400 can be mixed before and/or after insertion into the cartridge.

The beverage component 300 can be provided in the cup in many forms. For example, in some embodiments, the beverage component 300 is generally loose and non-compressed. In another embodiment, the beverage component 300 is generally compressed and/or compacted.

Certain Methods Related to Cartridges with Multiple Components

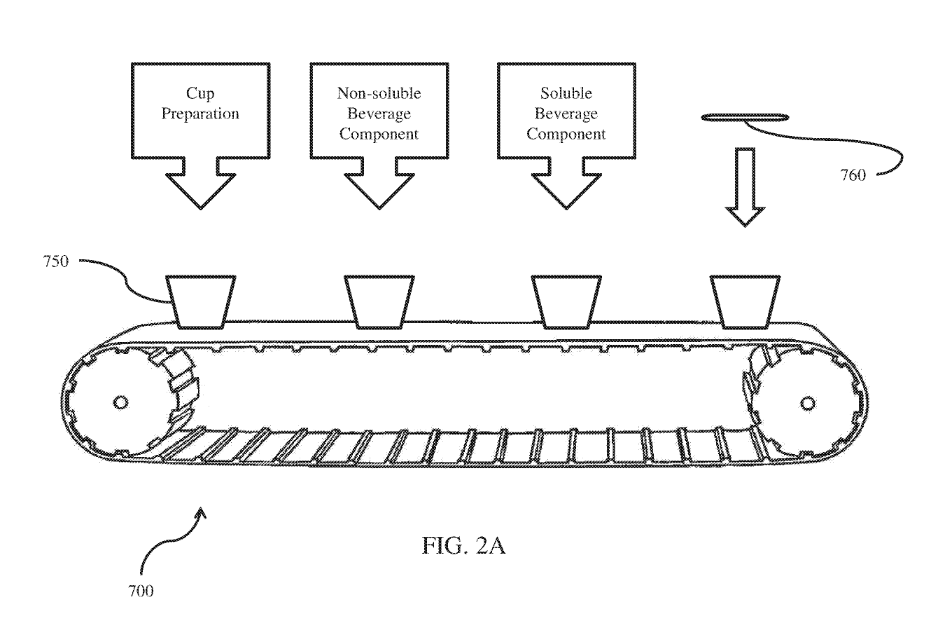

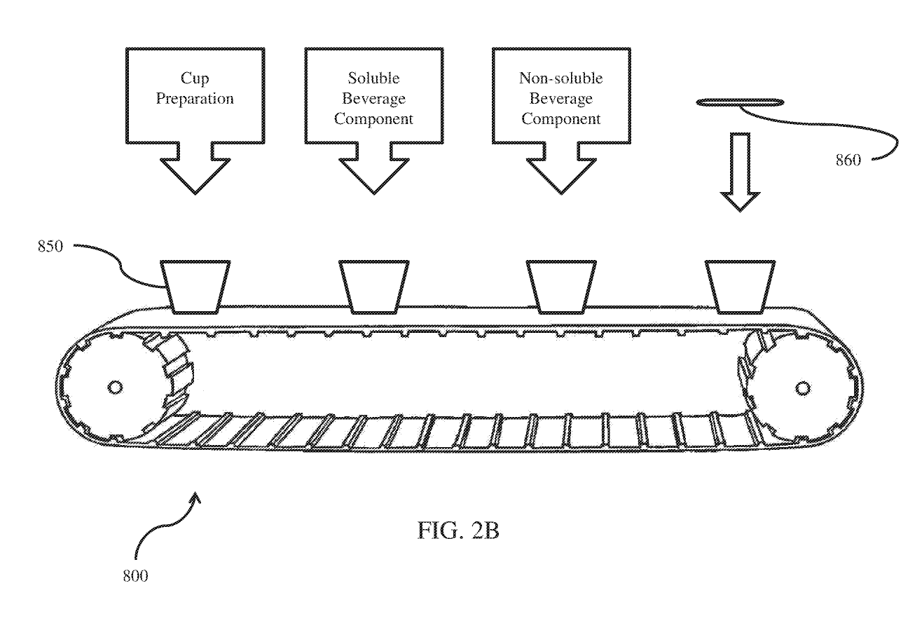

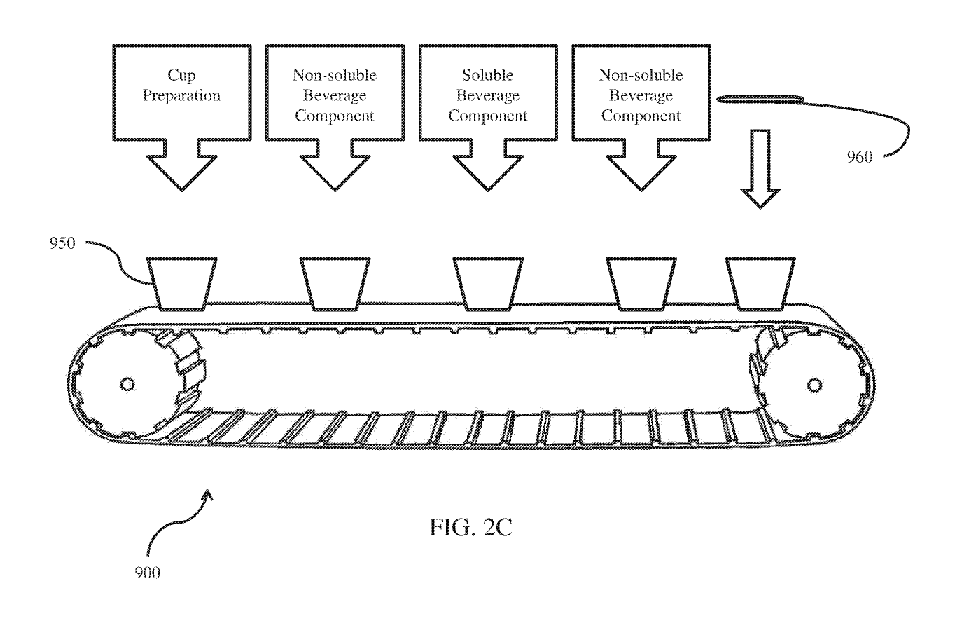

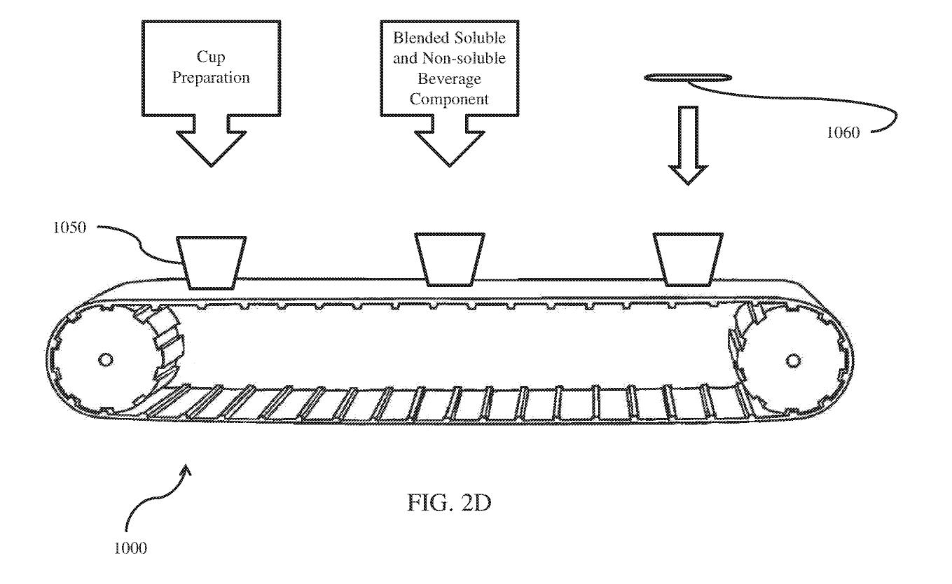

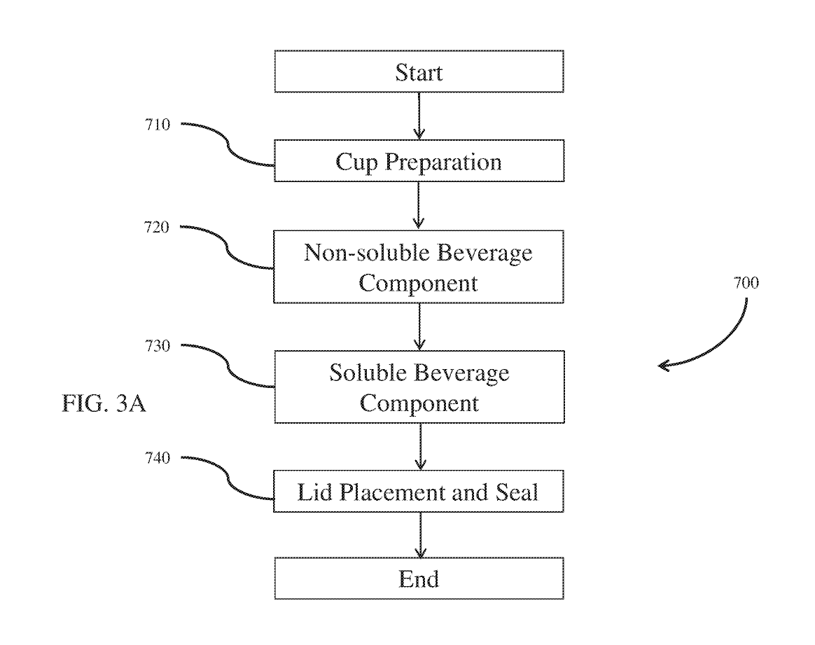

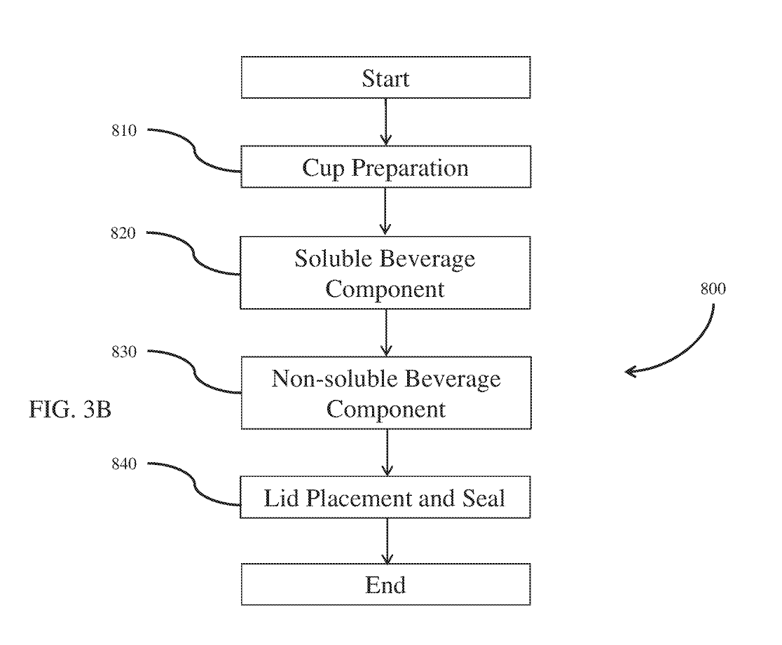

As discussed above, the cartridge 100 can include various layers and/or combinations of soluble beverage component 500 and non-soluble beverage component 400. FIGS. 3A-B illustrate flow-charts that provide an overview of methods for assembling a beverage cartridge with a non-soluble beverage component 400 and a soluble beverage component 500 according to certain embodiments. Each of the steps described below in FIGS. 3A-B is described in further detail according to certain embodiments with regard to FIGS. 2A-D.

FIGS. 2A and 3A illustrate a method 700 for assembling a beverage cartridge 750. In some embodiments, the method 700 can include block 710 that includes preparing the cup for assembly. In some embodiments, preparing the cup for assembly can include forming a cup according to one the embodiments described above with respect to FIGS. 1A-E. In some embodiments, forming a cup can include forming a cup with a bottom wall, a side wall and a lip onto which a lid can be attached. In some embodiments, preparing the cup can include forming a cup, inserting a filter within the cup and securing the filter to the cup by, for example, welding the filter to the cup. In some embodiments, the method for assembling the beverage cartridge 700 can include block 720 which describes first filling the cartridge 750 with a non-soluble beverage component 400. The method 700 can include block 730, which describes filling the cartridge 750 with a soluble beverage component 500. In some embodiments, the method 700 can include block 740 which describes placing and sealing the lid 760 to the cartridge 750. In some embodiments, an inert gas can be placed within the cartridge 750 before the cartridge is sealed with a lid and/or air can be removed from the cartridge before the cartridge is sealed. During this process, the soluble and/or in-soluble components can be shielded under an inert gas (e.g., nitrogen) blanket until the cartridge is sealed.

FIGS. 2B and 3B illustrates a method 800 for assembling a beverage cartridge 850 that is also illustrated in FIG. 1B. In some embodiments, the method 800 can include block 810 that includes preparing the cup for assembly. In some embodiments, the method 700 can include block 710 that includes preparing the cup for assembly. In some embodiments, preparing the cup for assembly can include forming a cup according to one the embodiments described above with respect to FIGS. 1A-E. In some embodiments, preparing the cup can include forming a cup, inserting a filter within the cup and securing the filter to the cup by, for example, welding the filter to the cup. In some embodiments, forming a cup can include forming a cup with a bottom wall, a side wall and a lip onto which a lid can be attached. The method 800 can include block 820 which describes first filling the cartridge 850 with a soluble beverage component 500. The method 800 can include block 830, which describes filling the cartridge 850 with a non-soluble beverage component 400. In some embodiments, the method 800 can include block 840 which describes placing and sealing the lid 860 to the cartridge 850. In some embodiments, an inert gas can be placed within the cartridge 850 before the cartridge is sealed with a lid and/or air can be removed from the cartridge before the cartridge is sealed. During this process, the soluble and/or in-soluble components can be shielded under an inert gas (e.g., nitrogen) blanket until the cartridge is sealed.

FIGS. 2A-D also illustrate schematic representations of multiple embodiments of methods for assembling the beverage cartridges illustrated in FIGS. 1A-D. In some embodiments, the soluble beverage component 500 can be composed of a fine (e.g. small, tiny) granular size as compared to the soluble component. Therefore, in some examples, the method for assembling the beverage cartridge can facilitate effective loading of the soluble beverage component 500 into the cartridge. As well, to facilitate the desired boldness and flavor profile of the prepared beverage, some embodiments of the method for assembling the beverage cartridge can facilitate the proper ratio of soluble beverage component 500 to non-soluble beverage component 400.

As an overview, in some embodiments, the filling systems for cartridges can be completed in discrete steps wherein the cartridge is moved down, for example, a conveyor mechanism. As illustrated in FIGS. 2A-D, each of the beverage cartridges shown on the conveyor mechanism represents a step in one embodiment of the assembling of the beverage cartridge. While the methods described in FIG. 2A-D illustrate the steps of adding the soluble beverage component 500 and non-soluble beverage component 400 at separate physical locations along an assembly process, the steps can also be done at the same location with different feed mechanisms than what is disclosed below.

In some embodiments, the cartridge assembly method includes separate filling mechanisms for the soluble beverage component 500, the non-soluble beverage component 400, and the mixed beverage component 600. In some examples, in areas where the beverage component is exposed, the beverage cartridge assembling system can be shielded under a blanket (e.g. nitrogen blanket) until the cartridge is sealed.

FIG. 2A illustrates a schematic representation for the method for assembling the beverage cartridge 700 with a beverage component 300 illustrated in FIG. 1A. As shown above, the beverage component illustrated in FIG. 1A includes a beverage component with a first layer of non-soluble beverage component 400 and a second layer of soluble beverage component 500.

In some embodiments, the method for assembling the beverage cartridge 700 can include preparing the cartridge 750 for assembly. In some examples, this can include obtaining (e.g., forming or otherwise manufacturing) the cartridge 750 according to the desired configuration, such as the configuration described above. In some embodiments, the method 700 can include block 710 that includes preparing the cup for assembly. In some embodiments, preparing the cup for assembly can include forming a cup according to one the embodiments described above with respect to FIGS. 1A-E. In some embodiments, forming a cup can include forming a cup with a bottom wall, a side wall and a lip onto which a lid can be attached. In some embodiments, preparing the cartridge 750 can include forming a cup, inserting a filter within the cup and securing the filter to the cup by, for example, welding the filter to the cup.

In some embodiments, the method for assembling the beverage cartridge 700 can first include filling the cartridge 750 with a non-soluble beverage component 400. In some embodiments, the beverage cartridge assembly system can include a filling system that contains a hopper filled with the non-soluble beverage component 400. In some embodiments the hopper can include one set of feed auger screws to load the non-soluble beverage component 400 into the cartridge 750.

In some embodiments, the method for assembling the beverage cartridge 700 can then include filling the cartridge 750 with a soluble beverage component 500. In some embodiments, the beverage cartridge assembly system can include a filling system that contains a hopper filled with the soluble beverage component. In some embodiments the hopper can include a screw auger that can be engineered to prevent free flow of the soluble beverage component 500 into the cartridge 750. Advantageously this can manage the fine (e.g. small, tiny) granules of the soluble beverage component and limit dusting in the feed process to prevent contamination of the edges of the lid 760 of the cartridge 750.

Thus, in the illustrated embodiments of FIGS. 2A-D, separate feed systems can be used for the non-soluble beverage component 400 and the soluble beverage component 500. In the illustrated embodiment, the feeding of non-soluble beverage component 400 and the soluble beverage component 500 is shown as being conducted at separate locations along an assembly path. However, in certain embodiments, the feeding of non-soluble beverage component 400 and the soluble beverage component 500 can occur at the same location along the assembly path but with different feed systems and/or steps and/or or a common feed system that includes components configured specifically for the non-soluble beverage component 400 or the soluble beverage component 500.

As discussed above, the method of assembling a beverage cartridge can facilitate a desired ratio of soluble beverage component 500 to non-soluble beverage component 400 is loaded (e.g. filled, assembled, poured) into the cartridge 750. In some embodiments, between 1 or about 1 to 4 or about 4 grams of soluble beverage component 500 can be filled into the cartridge 750. In some embodiments, between 22 or about 22 to 26 or about 26 grams of non-soluble beverage component 400 can be filled into the cartridge 750. The disclosed embodiments are not limited to these ranges and can also include the ranges and ratios described above and the amount of soluble beverage component 500 and non-soluble beverage component 400 can vary according to the desired boldness and flavor of the prepared beverage. In certain arrangements the above ratios and/or weight percentages can apply to arrangements where the non-soluble beverage component and the soluble beverage component are components of the same beverage. In certain arrangements, the non-soluble component is roasted ground coffee the soluble beverage can be soluble coffee such as coffee extract, freeze-dried and/or instant coffee

Some embodiments of the method for assembling the beverage cartridge 700 can include attaching a lid 760 to the rim of the cartridge 750. In some embodiments, the lid 760 can be secured or adhered to the cartridge 750 using any suitable adhesive or sealing techniques and materials, such as heat-sealing, crimping, gluing, UV-curing, applying ultrasonic or microwave energy (e.g. sonic welding), and otherwise.

In some embodiments, one or more of the steps described with respect to FIGS. 2A-D can be performed within an inert atmosphere blanket. In some embodiments, an inert gas can be placed within the cartridge before the cartridge is sealed with a lid and/or air can be removed from the cartridge before the cartridge is sealed.

As described below, the method described above with respect to FIG. 2A can be modified to change the order of insertion of the non-soluble beverage component 400 and soluble beverage component 500. FIGS. 2B-D will describe examples of these modifications and additional details and embodiments can be found above with reference to the description of FIG. 2A.

FIG. 2B illustrates a schematic representation for the method for assembling the beverage cartridge 800 with a beverage component 300 illustrated in FIG. 1B. The method for assembling the beverage cartridge 800 of FIG. 2B is similar to the method for assembling the beverage cartridge 800 illustrated above in FIG. 1B but in this embodiment the soluble beverage component 500 is inserted into the cartridge 850 before the non-soluble beverage component 400.

In the embodiment of FIG. 2B, the method for assembling the beverage cartridge 800 can include preparing the cartridge 850 for assembly. In some examples, this can include manufacturing the cartridge 850 according to the desired conformation described above and with respect to FIG. 2A. In certain arrangements, preparing the cartridge can include forming a cup, inserting a filter within the cup and securing the filter to the cup by, for example, welding the filter to the cup.

In some embodiments, the method for assembling the beverage cartridge 800 can first include filling the cartridge 850 with a soluble beverage component 500. In some embodiments, the beverage cartridge assembly system can include a filling system as described with respect to FIG. 2A that contains a hopper filled with the soluble beverage component 500. In some embodiments the hopper can include a screw auger that can be engineered to prevent free flow of the soluble beverage component 500 into the cartridge 850.

In some embodiments, the method for assembling the beverage cartridge 800 can then include filling the cartridge 850 with a non-soluble beverage component 400. In some embodiments, the beverage cartridge assembly system can include a filling system that contains a hopper filled with the non-soluble beverage component 400. In some embodiments the hopper can include one set of feed screws to load the non-soluble beverage component 400 into the cartridge 850.

As discussed above with reference to FIG. 2A, the method for assembling the beverage cartridge 800 can facilitate a desired ratio of soluble beverage component 500 to non-soluble beverage component 400 is loaded (e.g. filled, assembled, poured) into the cartridge 850.

As discussed for FIG. 2A, in some embodiments, the method for assembling the beverage cartridge 800 can include attaching a lid 860 to the rim of the cartridge 850. In some embodiments, the lid 860 can be secured or adhered to the cartridge 850 using any suitable adhesive or sealing techniques and materials, such as heat-sealing, crimping, gluing, UV-curing, applying ultrasonic or microwave energy (e.g. sonic welding), and otherwise.

FIG. 2C illustrates a schematic representation for the method for assembling the beverage cartridge 900 with a beverage component 300 illustrated in FIG. 1C.

As described above with respect to FIG. 2A, in some embodiments, the method for assembling the beverage cartridge 900 can include preparing the cartridge 950 for assembly. In some examples, this can include manufacturing the cartridge 950 according to the configurations described above. In certain arrangements, preparing the cartridge can include forming a cup, inserting a filter within the cup and securing the filter to the cup by, for example, welding the filter to the cup.

In some embodiments, the method for assembling the beverage cartridge 900 can first include filling the cartridge 950 with a non-soluble beverage component 400 as described with respect to FIG. 2A. In some embodiments, the beverage cartridge assembly system can include a filling system that contains a hopper filled with the non-soluble beverage component 400. In some embodiments the hopper can include one set of feed screws to load the non-soluble beverage component 400 into the cartridge 950.

In some embodiments, the method for assembling the beverage cartridge 900 can then include filling the cartridge 950 with a soluble beverage component 500 as described with respect to FIG. 2A. In some embodiments, the beverage cartridge assembly system can include a filling system that contains a hopper filled with the soluble beverage component 500. In some embodiments the hopper can include a screw auger that can be engineered to prevent free flow of the soluble beverage component 500 into the cartridge 950.

In some embodiments, the method for assembling the beverage cartridge 900 can include filling the cartridge 950 with another layer of non-soluble beverage component 400. As discussed above, the beverage cartridge assembly system can include an identical filling system as that provided for the first layer of non-soluble beverage component 400.

As discussed above, the method for assembling the beverage cartridge 900 can facilitate a desired ratio of soluble beverage component 500 to non-soluble beverage component 400 is loaded (e.g. filled, assembled, poured) into the cartridge 950.

As discussed for FIGS. 2A-B, in some embodiments, the method for assembling the beverage cartridge 900 can include attaching a lid 960 to the rim of the cartridge 950. In some embodiments, the lid 960 can be secured or adhered to the cartridge 950 using any suitable adhesive or sealing techniques and materials, such as heat-sealing, crimping, gluing, UV-curing, applying ultrasonic or microwave energy (e.g. sonic welding), and otherwise. In certain arrangements, the method of FIG. 2C, can be modified to include additional steps of feeding soluble and/or non-soluble components and/or one or more of steps can be rearranged in order.

FIG. 2D illustrates a schematic representation for the method for assembling the beverage cartridge 1000 with a beverage component 300 illustrated in FIG. 1D.

In some embodiments, the method for assembling the beverage cartridge 1000 can include preparing the cartridge 1050 for assembly as described with respect to FIG. 2A.

In some embodiments, the method for assembling the beverage cartridge 1000 can first include filling the cartridge 1050 with a beverage component 300. As discussed above, in some embodiments, the beverage component 300 can be prepared prior to the method for assembling the beverage cartridge 1000. In some embodiments, the beverage cartridge assembly system can include a filling system that contains a hopper filled with the beverage component 300. In some examples, the hopper can include one set of feed screws to load the non-soluble beverage component 400 into the cartridge 1050. In additional examples, the hopper can include a screw auger that can be engineered to prevent free flow of the beverage component 300 into the cartridge 1050. Advantageously this can manage the fine (e.g. small, tiny) granules of the soluble beverage component 500 in the beverage component 300 and limit dusting in the feed process to prevent contamination of the edges of the lid 1060 of the cartridge 1050.

In other embodiments, the beverage component 300 can be prepared as the cartridge 1050 is being filled. In some examples, the cartridge 1050 would receive soluble beverage component 500 and non-soluble beverage component 400 simultaneously from a plurality of hoppers described above.

As discussed for FIGS. 2A-C, in some embodiments, the method for assembling the beverage cartridge 1000 can include attaching a lid 1060 to the rim of the cartridge 1050. In some embodiments, the lid 1060 can be secured or adhered to the cartridge 1050 using any suitable adhesive or sealing techniques and materials, such as heat-sealing, crimping, gluing, UV-curing, applying ultrasonic or microwave energy (e.g. sonic welding), and otherwise.

### Certain Terminology

As used herein, the term “beverage” has its ordinary and customary meaning, and includes, among other things, any edible liquid or substantially liquid substance or product having a flowing quality (e.g., juices, coffee beverages, teas, frozen yogurt, beer, wine, cocktails, liqueurs, spirits, cider, soft drinks, flavored water, energy drinks, soups, broths, combinations of the same, or the like).

The term “pod,” as used herein, has its ordinary and customary meaning, and includes, among other things, cartridges, capsules, canisters, pucks, pads, and the like, whether or not such pods are capable of and/or configured to be pierced or otherwise ruptured to form an inlet into and/or outlet from the pod.

Although certain embodiments have been described herein with respect to coffee, the cartridges described herein can include particulate materials or components for producing many other types of beverages, such as a chocolate based product (e.g., hot cocoa), tea, juice, and other beverages. Further, although some embodiments have been disclosed in which liquid is introduced into the cartridge, the introduction of other phases is contemplated. For example, in some embodiments, steam or a combination of steam and liquid water is introduced into the cartridge. Additionally, although certain embodiments have been disclosed that include an instant beverage component, the term “instant beverage component” is not limited to only a single component. Rather, the instant beverage component can comprise one component (e.g., coffee) or a plurality of components (e.g., coffee and a sweetener).

Conditional language, for example, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Although certain embodiments and examples have been described herein, it will be understood by those skilled in the art that many aspects of the methods and devices shown and described in the present disclosure may be differently combined and/or modified to form still further embodiments or acceptable examples. All such modifications and variations are intended to be included herein within the scope of this disclosure. A wide variety of designs and approaches are possible. No feature, structure, or step disclosed herein is essential or indispensible.

Some embodiments have been described in connection with the accompanying drawings. However, it should be understood that the figures are not drawn to scale. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount or equal to or greater than 10% of the stated amount. The term “generally” as used herein represents a value, amount, or characteristic that predominantly includes or tends toward a particular value, amount, or characteristic. The ranges disclosed herein also encompass any and all overlap, sub-ranges, and combinations thereof. Language such as “up to,” “at least,” “greater than,” “less than,” “between,” and the like include the number recited. Numbers preceded by a term such as “about” or “approximately” include the recited numbers and should be interpreted based on the circumstances (e.g., as accurate as reasonably possible under the circumstances, for example. For example, “about 1 gram” includes “1 gram.”

### SUMMARY

Although this disclosure describes certain embodiments and examples of beverage preparation systems, many aspects of the methods and devices shown and described in the present disclosure may be combined differently and/or modified to form still further embodiments or acceptable examples. All such modifications and variations are intended to be included herein within the scope of this disclosure. Indeed, a wide variety of designs and approaches are possible and are within the scope of this disclosure. For example, although some embodiments have been disclosed in which liquid water is introduced into the cartridge, the introduction of other liquids (e.g., milk) and/or other phases (e.g., steam) is contemplated as well. While illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations, arrangements and/or embodiments can also be implemented in combination in a single implementation arrangements and/or embodiments. Conversely, various features that are described in the context of a single implementation arrangements and/or embodiments can also be implemented in multiple implementations arrangements and/or embodiments separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. However, the figures are not drawn to scale. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage preparations systems, components, and related methods have been disclosed. Although the systems have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. A beverage cartridge for use with a single-serve beverage machine, the cartridge including:
a cup having a bottom wall, a side wall and a lid;
a beverage component disposed in the cup, wherein the beverage component includes a soluble beverage component and a non-soluble beverage component, wherein the soluble beverage component and the non-soluble beverage component are soluble and non-soluble components of a same type of beverage.

2. The single-serve beverage cartridge of claim 1, wherein the non-soluble beverage component forms a first layer of the beverage component and the soluble beverage component forms a second layer.

3. The single-serve beverage cartridge of claim 1, wherein the soluble beverage component forms a first layer of the beverage component and the non-soluble beverage component forms a second layer.

4. The single-serve beverage cartridge of claim 1, wherein the non-soluble beverage component forms a first layer of the beverage component, the soluble beverage component forms a second layer, and the non-soluble beverage component forms a third layer of the beverage component.

5. The single-serve beverage cartridge of claim 1, wherein cup includes a shoulder disposed generally opposite the bottom wall and the lid is joined to the shoulder.

6. The single-serve beverage cartridge of claim 1, wherein the non-soluble beverage component is ground coffee.

7. The single-serve beverage cartridge of claim 6, wherein the soluble beverage component is freeze-dried or instant coffee.

8. The single-serve beverage cartridge of claim 7, wherein the non-soluble beverage component includes 22-26 grams of roast and/or ground coffee.

9. The single-serve beverage cartridge of claim 8, wherein the soluble beverage component includes 1-4 grams of freeze-dried or instant coffee.

10. The single-serve beverage cartridge of claim 6, wherein the soluble beverage component includes a portion of microground coffee.

11. The single-serve beverage cartridge of claim 1 wherein the lid and the bottom wall are each configured to be pierced to allow the flow of liquid therethrough.

12. The single-serve beverage cartridge of claim 1 wherein the cartridge includes an element configured to retain the non-soluble components within the cartridge.

13. The single-serve beverage cartridge of claim 12 wherein the element is a filter.

14. A method of assembling a single-serve beverage cartridge, method including:
filling a cup with a beverage component including a soluble beverage component and a non-soluble beverage component; and
sealing the beverage component within the cup.

15. The method of claim 14, wherein filling the cup includes providing a first layer of non-soluble beverage component and providing a second layer of soluble beverage component.

16. The method of claim 14, wherein filling the cup includes providing a first layer of soluble beverage component and providing a second layer of non-soluble beverage component.

17. The method of claim 14, wherein filling the cup includes providing a first layer of non-soluble beverage component, providing a second layer of soluble beverage component, and providing a third layer of non-soluble beverage component.

18. The method of claim 14, wherein filling the cup includes providing a beverage component with a combination of soluble beverage component and non-soluble beverage component.

19. The method of claim 14, wherein the non-soluble beverage component is ground coffee.

20. The method of claim 19, wherein the soluble beverage component is freeze-dried or instant coffee.

21. The method of claim 20, wherein the non-soluble beverage component includes 22-26 grams of roast and/or ground coffee

22. The method of claim 21, wherein the soluble beverage component includes 1-4 grams of freeze-dried or instant coffee.

23. The method of claim 20, wherein the soluble beverage component includes a portion of microground coffee.

24. The method of claim 14, wherein the soluble beverage component and a non-soluble beverage component are soluble and non-soluble components of a same type of beverage.

25. The method of claim 14 comprising
forming a cup having a bottom wall and a shoulder disposed generally opposite the bottom wall.

26. The method of claim 25 wherein sealing the beverage component within the cup comprises joining a lid with the shoulder.

27. The method of claim 14 comprising removing air from the cup and/or filling the cup with an inert gas before sealing the beverage component within the cup.
